(19) United States
(12) Patent Application Publication
(10) Pub. No.: US 2005/0282120 A1
(43) Pub. Date: Dec. 22, 2005

(54) Teaching methods and apparatus for children

(76) Inventor: Ann Whittaker, Orem, UT (US)

Correspondence Address: Kulaniakea Fisher;Rader, Fishman & Grauer PLLC, Suite #150, 10653 S. River Front Pkwy., South Jordan, UT, 84095, US

(21) Appl. No.: 10/871,773

(22) Filed: Jun. 18, 2004

(51) Int. Cl. G09B 19/00

(52) U.S. Cl. 434/155

(57) ABSTRACT

A teaching method and apparatus are provided for using a workshop and a classroom to assist in teaching at least one child about a topic. The method comprises reading a writing about the topic with or to the child in the classroom, creating an item in the workshop relating to the topic, and discussing the created item with the child. The classroom and workshop may be located in a simulated village, such as a fairy tale type village. A fantasy-type structure in the simulated village, such as a simulated tree, has an entry to allow access for a child into an area inside the structure.

### BACKGROUND

1. Field of Invention

The present disclosure relates to teaching methods and apparatus, and more particularly to teaching methods and apparatus for children.

2. Background

In today's society, daycare centers and pre-school centers have proliferated, with more children being introduced to formal learning and studying at an early age. It is very common for children to be placed in a school-like setting, such as preschool, pre-kindergarten and kindergarten (ages 3 through 6). At such early ages, a child's attention span is short, there is little personal history of learning to draw from, and a child may be wary or even frightened at being left alone with relatively unknown adults and other children. Consequently, major challenges are presented to develop methods and apparatus for teaching young children and for motivating them to learn. Moreover, as children are placed in new surroundings, there is a challenge to find ways to put them at ease and to help them feel at home in new surroundings.

Many children have special needs, either because of physical or mental handicaps, or because of emotional problems. These special needs can interfere and hamper the teaching process, and heighten frustrations. Such needs increase the importance of developing good teaching methods and apparatus, in order to reach such children and help them to learn.

One of the best ways to reach children and maintain their interest has been to appeal to their curiosity, creativity and imagination, as well as their desire to play and have fun. One example is shown in U.S. Pat. No. 5,655,910 (Troudet), in which children are taught games and creative concepts to associate hands, digits, indicia and characters in order to enhance teaching keyboarding. In U.S. Pat. No. 5,980,354 (Prest), storyboard toys are utilized to nurture learning through associating various storyboard pieces with characters and figures.

Accordingly, new methods and apparatus are needed to appeal to the imagination and creativity of children and to peak their curiosity. Moreover, activities are needed that engage children in teaching activities while incorporating playful activities and having fun. In addition, a learning environment is needed that gives children a feeling of comfort and puts them at ease. Further, teaching methods and apparatus are needed to overcome the barriers of children with special needs and to stimulate their interest.

### SUMMARY

In one implementation of the present disclosure, a teaching method and apparatus are provided for using a workshop and a classroom to assist in teaching at least one child about a topic. The method comprises reading a writing about the topic with or to the child in the classroom, creating an item in the workshop that was mentioned in the story, and discussing the created item with the child.

In another implementation of the present disclosure, a teaching method and apparatus are provided for use in motivating children to learn, including providing a simulated village having a plurality of shops, providing at least one classroom in the simulated village, providing at least one workshop in one of the plurality of shops, and providing an activity for the children in the workshop related to a topic studied in the classroom.

In another implementation of the present disclosure, a teaching method and apparatus are provided for use in motivating children to learn in a classroom, including providing a fantasy-type structure near or in the classroom, providing an area in the fantasy-type structure to accommodate at least one child, and allowing access through an entry way to the area.

### BRIEF DESCRIPTION OF THE DRAWINGS

The above-mentioned features and other features and advantages of this disclosure will become more apparent and the disclosure will be better understood by reference to the following description of an exemplary implementation taken in conjunction with the accompanying drawings, wherein:

FIG. 1 is a generalized pictorial view of a childrens' school environment in the form of a simulated village or fairy tale setting;

FIGS. 2, 3 and 4 are pictorial views of the fronts of shops and cottages in the simulated village shown in FIG. 1;

FIGS. 5A and 5B are pictorial views of a simulated tree in the simulated village of FIG. 1;

FIG. 6 is a pictorial view of a classroom according to one implementation of the present disclosure;

FIG. 7 is a pictorial view of a kitchen workshop in the village shown in FIG. 1;

FIG. 8 is a pictorial view of a tailor workshop in the village shown in FIG. 1;

FIG. 9 is a pictorial view of a wood workshop in the village shown in FIG. 1; and

FIG. 10 is a pictorial view of a science workshop in the village shown in FIG. 1;

Throughout the drawings, identical reference numbers may designate similar, but not necessarily identical, elements. The examples herein illustrate selected implementations of the disclosure in certain forms, and such exemplification is not to be construed as limiting the scope of the disclosure in any manner.

### DETAILED DESCRIPTION

In the present description, methods and apparatus are disclosed that involve one or more workshops as tools to supplement teaching of concepts and stories to children in the classroom. If a story is being taught to the children, a workshop may be used to act out the story or to create and/or use various key items in the story. If a concept is being taught to the children, a workshop may be utilized to enable the children to have a hands-on experience with the concept being discussed. These workshops provide opportunities for the children to learn basic skills that are needed throughout life. Such workshops may also open up direction to future career paths and many growth possibilities.

In addition, the present description includes methods and apparatus for placing the children in a relaxed and stimulating environment. A simulated village provides a feeling of safety and nurturing, where children can discover their unique potential. The village is associated with the classroom in various ways. For example, the classroom can be disposed as a part of the simulated village to give a sense of community and belonging. In addition, the simulated village may have fantasy qualities, such as a village that appears to be out of a fairy tale, in order to stimulate interest and creativity and to place the children at ease.

Another characteristic of the present description includes methods and apparatus for utilizing a simulated structure, such as a simulated tree, to enhance the interest of the children. The simulated tree can be used as a symbol of knowledge, life and growth, as well as of being a protective umbrella for the children and a reminder of their potential. In addition, the tree may have a hollow trunk, with a door that allows access to a room in the trunk. The room can be used as a reward for achievement or good behavior, or can be a time-out place for calming down from excitement or a disturbance.

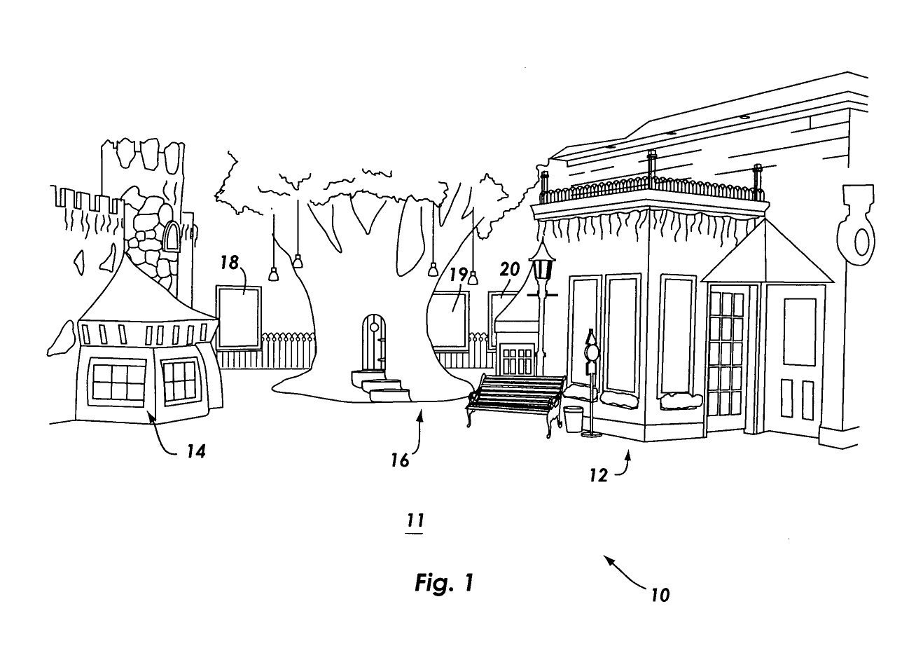

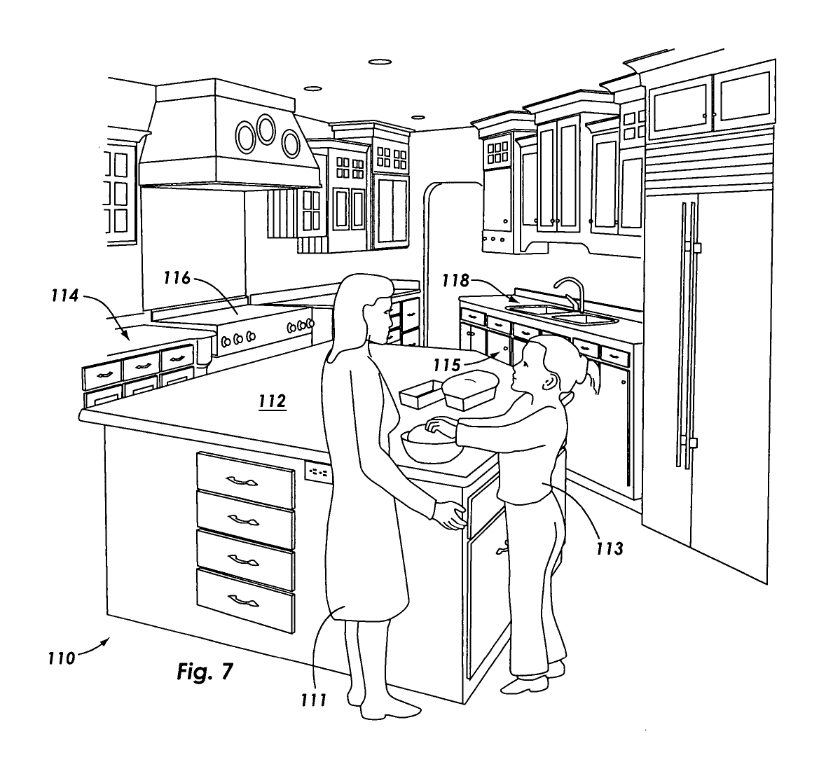

Looking now at FIG. 1, a children's school environment is shown in the form of a European or fairy tale village 10. The village 10 is comprised of a village square 11 surrounded by several simulated shops and cottages, such as shop front 12 and cottage 14, which are reminiscent of shops or cottages in fairy tales. A large simulated tree 16 is situated in a central position in the village 10 to provide a symbolic presence. Classrooms 18, 19 and 20 may be disposed near the tree Other areas, which may include workshops, such as those discussed with reference to FIGS. 7-10 may also be provided. These workshops may be separate from the classrooms.

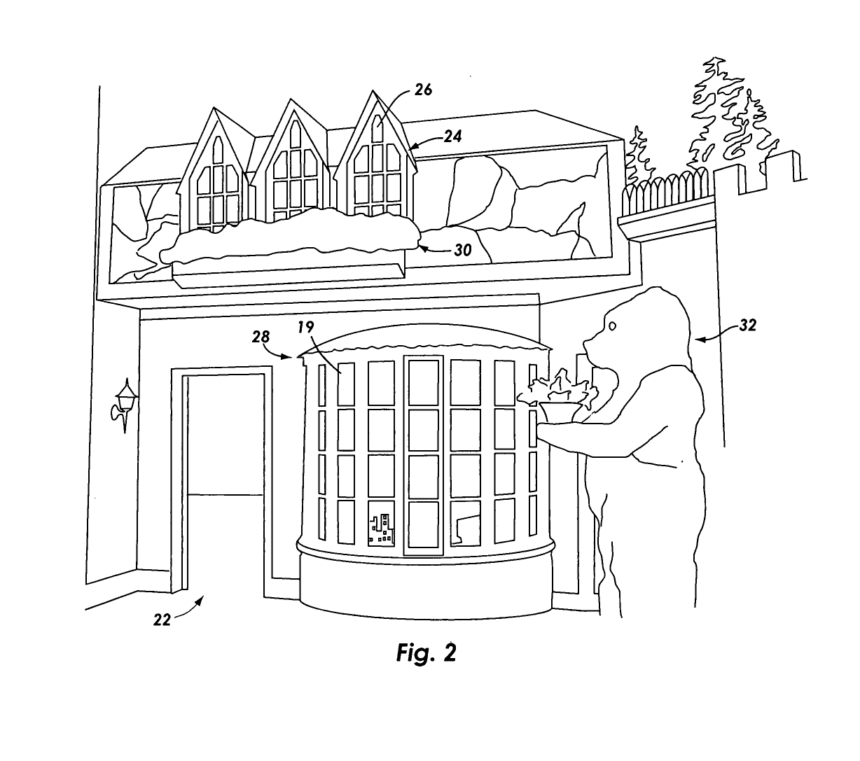

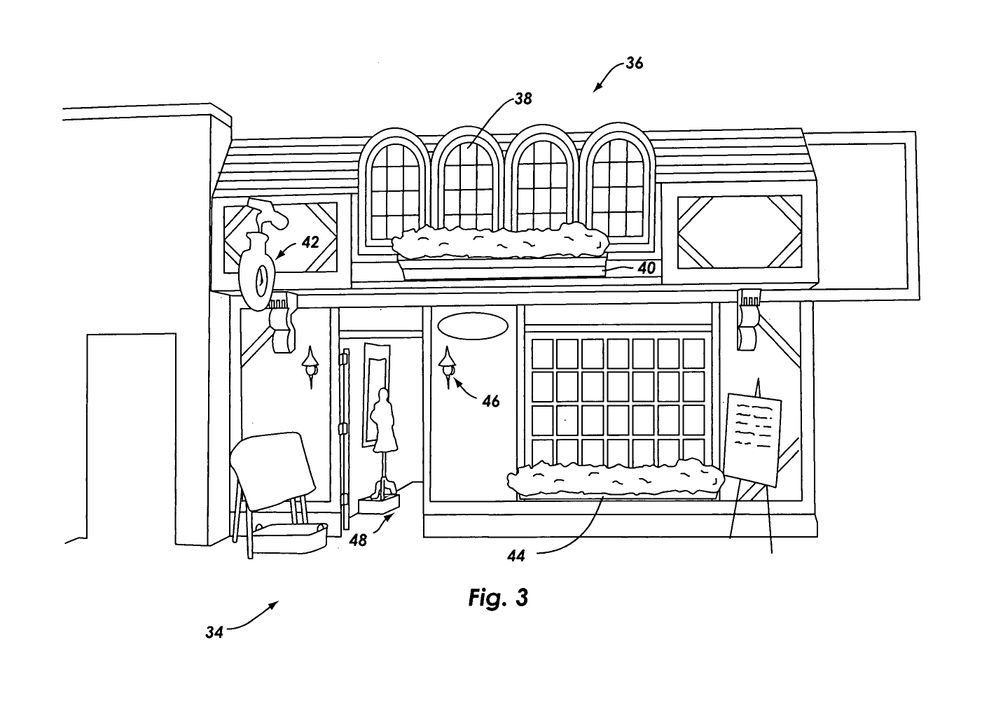

As seen in FIG. 2, a shop front 22 has unique fantasy-like features, including gables 24 with picturesque windows 26, window boxes with flowers 30 below gables 24, a bay window 28, and a bear statue 32 holding a flower tin. Similarly, in FIG. 3, a shop front 34 includes rounded gables 36 with quaint windows 38 and a window box 40. A clock 42 hangs above the shop front 34, and another window box 44 is located in the front of the shop. Door lamps 46 are located on either side of a doorway 48 leading into the shop.

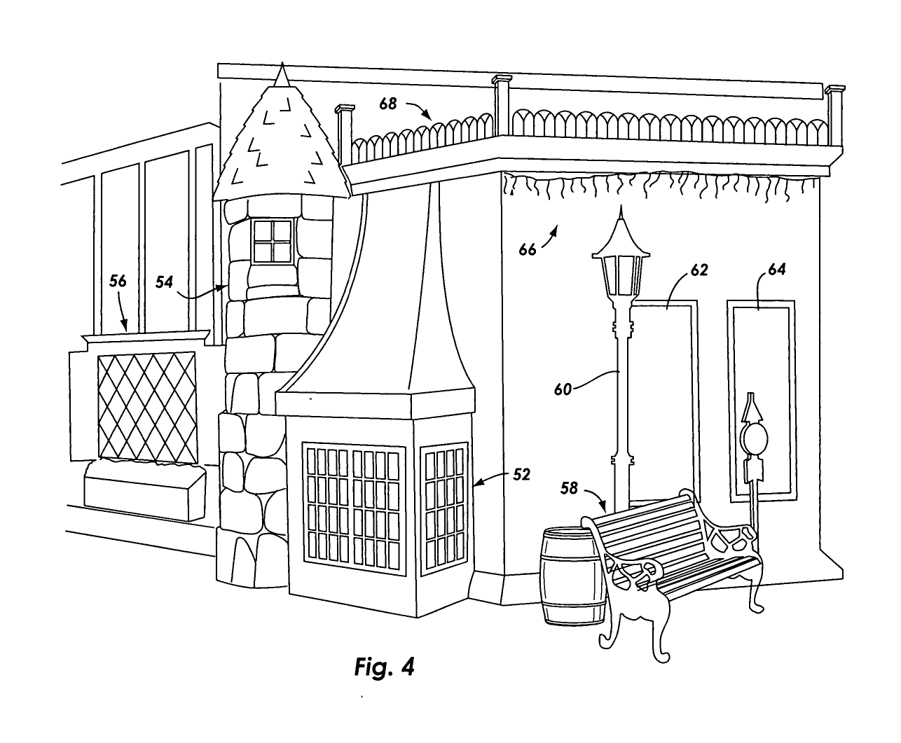

FIG. 4 shows another picturesque scene in village that is reminiscent of a quaint street setting. A shop window casing 52 is disposed next to a tower 54 which is adjacent to a lattice-formed window 56. An old-fashioned bench 58 is positioned near a street lamp 60 in front of windows 62 and 64 for a shop or classroom. Decorative lighting 66 and a simulated roof fence 68 add to the atmosphere.

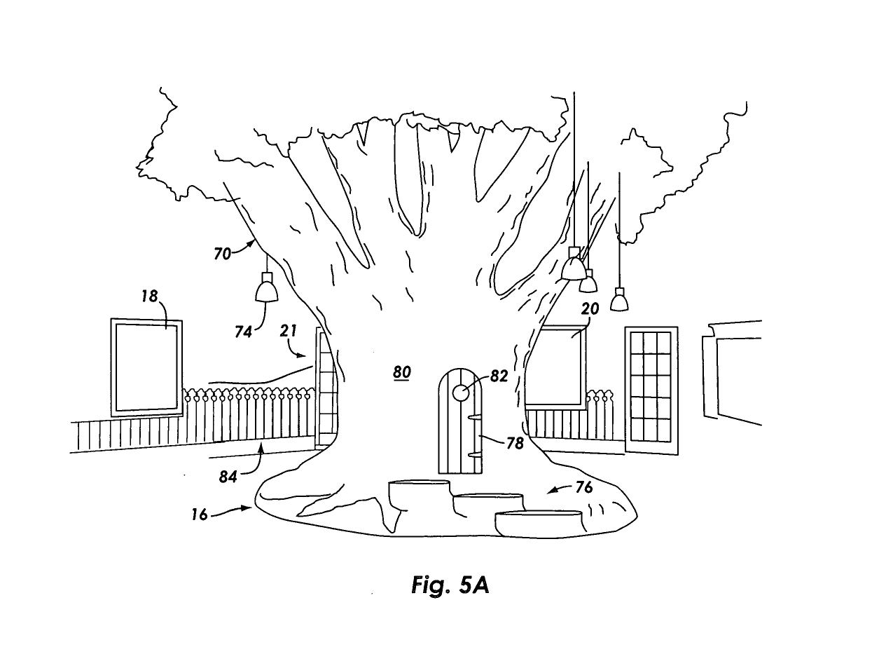

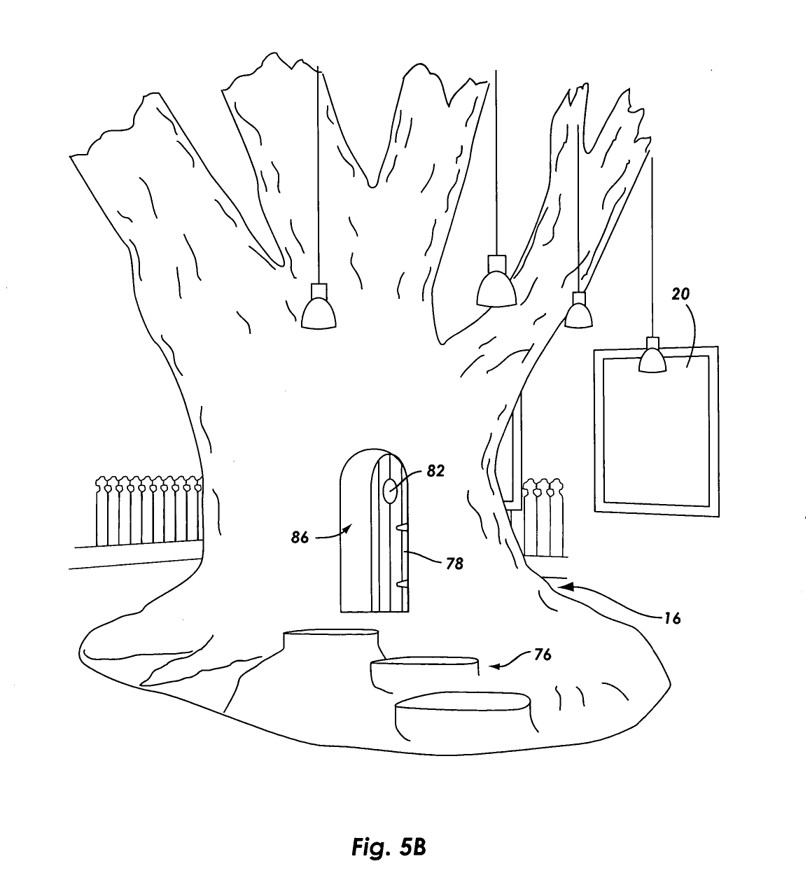

Looking now at FIGS. 5A and 5B, the simulated tree 16 is shown in more detail. The tree may be made of fiberglass or other durable material. It includes several sturdy branches 70 that support various lights 74 thereon. A few steps 76 lead up to a door 78 in the tree trunk 80, having a small round window 82 therein. Tree 16 is surrounded by windows 18, 19 (not shown) and 20 looking in on children's classrooms. Door 21 leads into one of the classrooms. An imitation picket fence 84 is shown behind tree 16. FIG. 5B is a close-up of tree 16 showing the door 78 partially open to reveal a room 86 in a hollow portion of tree trunk 80. Room 86 may be used as a reward for achievement or good behavior, a time-out place for children or simply a place to explore or to be alone.

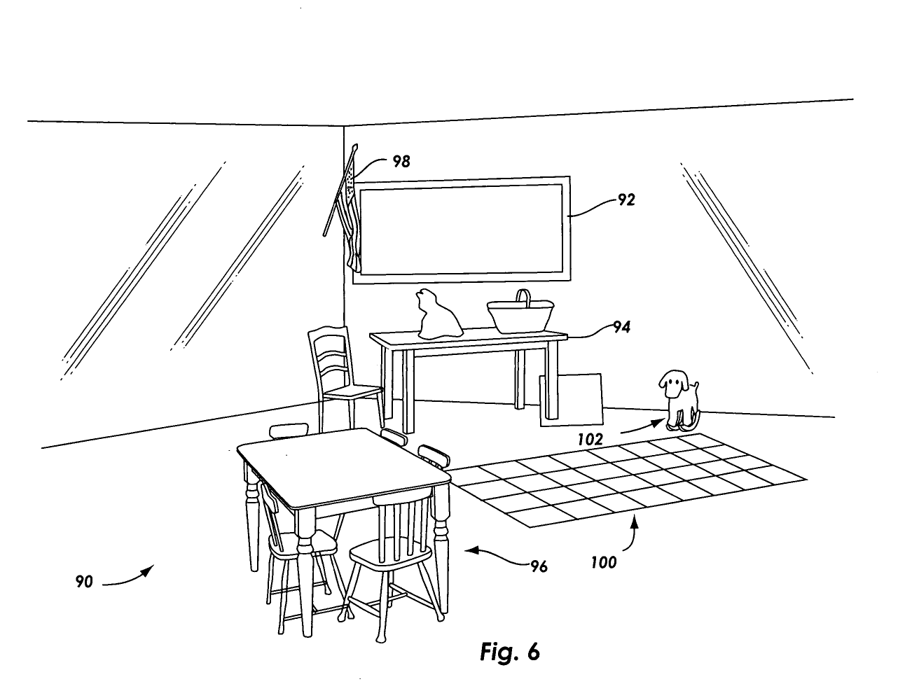

FIG. 6 is indicative of one or more classrooms 90 in the village 10 shown in FIG. 1. One room may be used for preschool children, another room may be a classroom for pre-kindergarten children, and a third room may be designated for kindergarten children. Classroom 90 is a typical room for small children, with a blackboard 92, a teacher's desk 94, children's table and chairs 96, a flag 98, a play area 100 and a rocking toy 102.

Of course many variations of the foregoing arrangement are possible. Multiple kindergarten rooms may be needed for larger numbers of children of that age. In contrast, some age levels may be entirely absent, depending on the focus of each school.

FIG. 7 is a pictorial view showing a kitchen workshop 110 inside of one of the shop fronts shown previously. A large work counter 112 is provided, surrounded by additional counter space 114 and 115 and a stove 116 located in counter 114. A sink 118 is disposed in counter 116. An instructor 111 is shown teaching a child 113 cooking skills. Kitchen 110 serves as a workshop to learn cooking and related skills and to act out any cooking aspects of stories being studied by the children. In particular, the children may be able to wear a costume while acting out specific aspects of stories being studied by the children. If a particular item is used in a story, the children may then use a similar item, while wearing a costume, in the workshop or elsewhere.

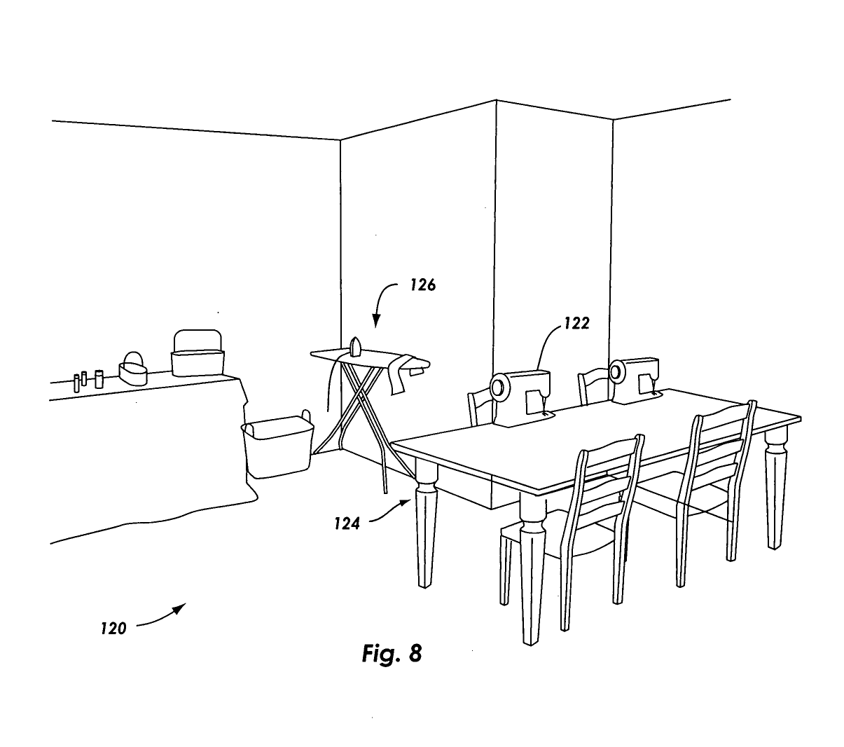

FIG. 8 is a pictorial view showing a tailor shop 120 inside of one of the store fronts. Sewing machines 122 are set up on tables 124 for use by the children. An ironing board and iron 126 are located in the corner. A teacher's desk 128 is situated at the front of the classroom, and other items needed by the teacher and children are shown.

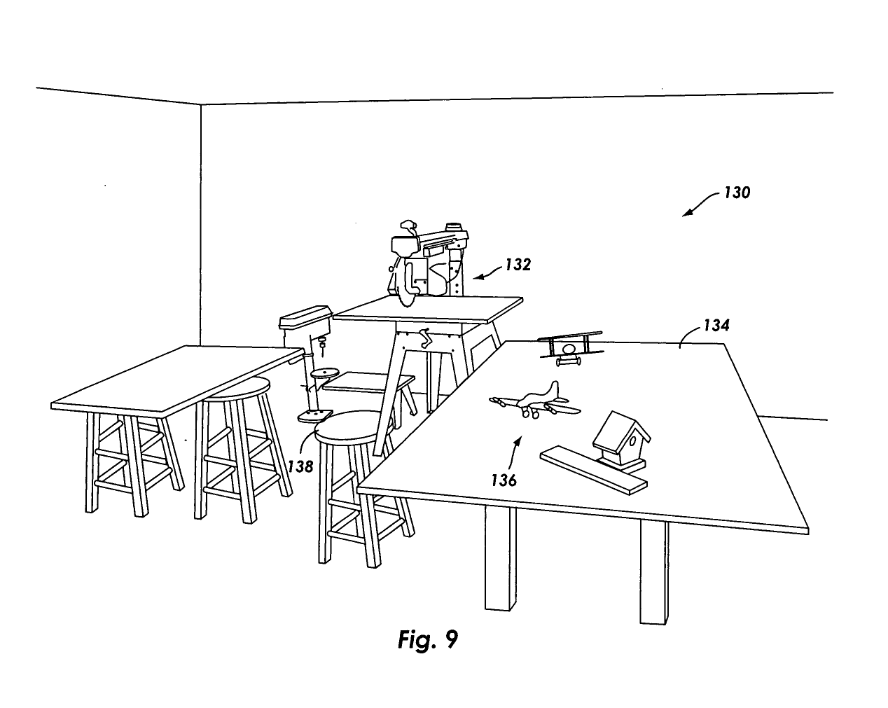

FIG. 9 is another pictorial view showing a woodworking workshop 130 for children. A saw 132 is arranged for easy access to the children under a teacher's supervision. A woodworking table 134 has a variety of work pieces 136 thereon and a stool 138 nearby.

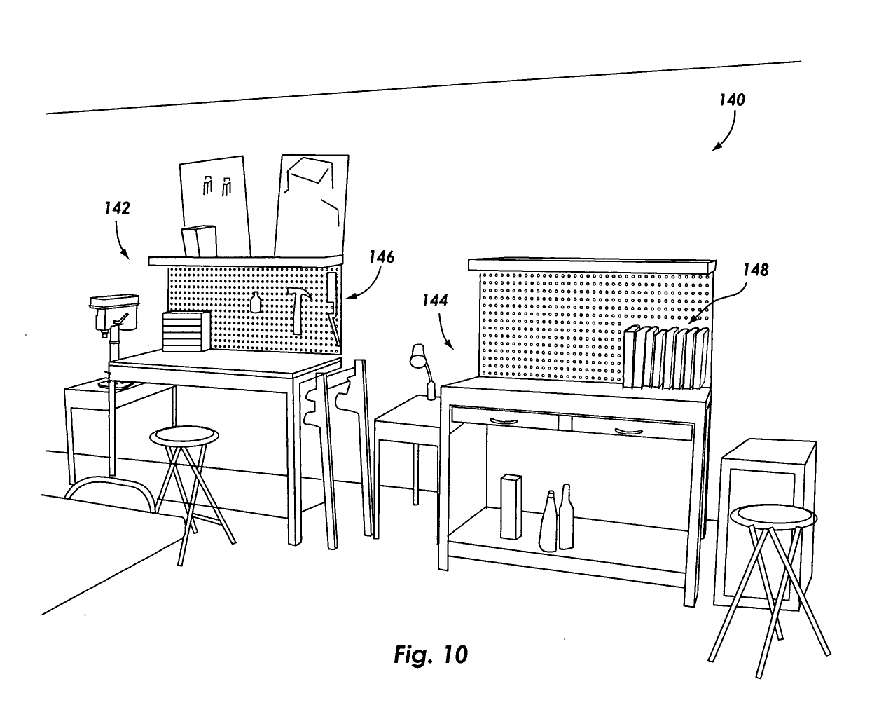

FIG. 10 is a depiction of a science workshop 140 for children according to the present application. Work benches 142 and 144 are equipped with a variety of implements 146 and books 148 thereon.

It should be understood that various other workshops may be provided within the scope of the present invention. For example, a simulated bank may be provided with counters and teller apparatus for use in teaching children about bank accounts and other financial matters. An art workshop may also be provided for children to learn various artistic skills, including tables with benches for the children to paint, draw, color, or engage in other artistic activities. Other workshops may also be provided to study computers, photography and other subjects, as well as to learn various basic skills.

As previously mentioned, the foregoing workshops are meant to be used in conjunction with classroom studies for the children to enhance their learning experience. In one embodiment, a workshop may be used to carry out an activity depicted in a children's story. For example, in the little red hen story, the hen bakes some bread. At that point in the story, or after the story has been concluded, the children may go into the kitchen or baking workshop, depicted in FIG. 7, with the teacher or a cooking instructor and participate in baking bread. The bread may also be eaten by the children, to further enhance the experience. Likewise, when reading the story about Pinocchio, the children may go into the woodworking workshop, shown in FIG. 9, and make a wooden puppet, under proper supervision.

In another application of the present disclosure, the workshops may be used to build skills that are studied in the classroom. For example, children may be told about simple science concepts in the classroom. Then the children may go with the teacher, or with a science instructor, to the science workshop and conduct a simple experiment, under proper supervision, to enhance the learning experience of the children. Likewise, children may be taught about the basic process involved in having a bank account. They may then go to the bank workshop and actually open an account, as well as participate in making deposits and withdrawals.

While this disclosure has been described as having a preferred design, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of using a workshop and a classroom, both located in a learning center, to assist in teaching at least one child about a topic, comprising:
(a) reading a writing about the topic with or to the child in the classroom;
(b) creating an item in the workshop that was mentioned in the story; and
(c) discussing the created item with the children.

2. The method of claim 1, wherein the step of creating the item includes teaching several children and having one of the children participate in creating the item.

3. The method of claim 2, further comprising having at least one of the children consume or use the created item.

4. The method of claim 1, wherein the writing is a story.

5. The method of claim 4, wherein the step of creating the item includes teaching several children and having at least one of the children assume the role of a character in the story.

6. The method of claim 5, wherein the one child dresses in costume for the character.

7. The method of claim 4, further including acting out the story in the workshop.

8. The method of claim 7, wherein at least one of the children acts out the story by using the item.

9. The method of claim 8, wherein the step of using the item follows the plot of the story.

10. The method of claim 1, wherein the child is a preschool child.

11. The method of claim 1, wherein the classroom and the workshop are located separate from each other.

12. A teaching aid for assisting at least one child to understand a topic studied by the child in a classroom located in an education center, comprising:
a. a workshop area in the education center, separate from the classroom;
b. a device in the workshop area for creating an item relating to the topic.

13. The teaching aid of claim 12, wherein the topic studied in the classroom is a story.

14. The teaching aid of claim 13, further comprising means in the workshop for acting out the story that is studied in the classroom.

15. The teaching aid of claim 14, wherein the means for acting out the story comprises a costume to be worn by the child for assuming the role of a character in the story.

16. The teaching aid of claim 12, wherein the workshop is a bakery or kitchen and the device for creating an item is a baking device in the bakery or kitchen.

17. The teaching aid of claim 12, wherein the workshop is a sewing room and the device for creating an item is a sewing device in the sewing room.

18. The teaching aid of claim 12, wherein the workshop is a woodwork shop and the device for creating an item is a carpentry device in the woodwork shop.

19. The teaching aid of claim 12, wherein the workshop is a photography studio and the device for creating an item is a photographic device in the photography studio.

20. The teaching aid of claim 12, wherein the workshop is a simulated bank and the device for creating an item is banking device in the simulated bank.

21. The teaching aid of claim 11, wherein the child is a preschool child.

22. A teaching method for use in motivating children to learn, comprising:
(a) providing a simulated village having a plurality of shops therein;
(b) providing at least one classroom in the simulated village;
(c) providing at least one workshop in one of the plurality of shops;
(d) studying a topic in the classroom; and
(e) providing an activity for the children in the workshop related to a topic studied in the classroom.

23. The teaching method of claim 22, wherein providing the simulated village comprises providing a simulated village that has the appearance of a fairy tale type village.

24. The teaching method of claim 22, wherein studying the topic includes reading a story with the children in the classroom.

25. The teaching method of claim 24, further comprising providing apparatus in the workshop for conducting activities for the children relating to the story studied in the classroom.

26. The teaching method of claim 22, further comprising the topic is a fairy tale.

27. The teaching method of claim 26, further comprising providing apparatus in the workshop for conducting activities for the children relating the topic studied in the classroom.

28. A teaching aid for use in motivating children to learn, comprising:
(a) a simulated village having a plurality of shops and cottages;
(b) at least one classroom in the simulated village;
(c) at least one workshop in the simulated village: and
(d) means in the workshop for providing an activity for the children related to a topic studied in the classroom.

29. The teaching aid of claim 28, wherein the simulated village comprises a simulated village that has the appearance of a fairy tale type village.

30. The teaching aid of claim 28, wherein the means in the workshop is apparatus for conducting activities for the children relating to a skill studied in the classroom.

31. The teaching aid of claim 28, wherein the means in the workshop is apparatus for conducting activities for the children relating to a story studied in the classroom.

32. A teaching method for use in motivating children to learn in a classroom, comprising:
a. providing a fantasy-type structure near or in the classroom;
b. providing an area in the fantasy-type structure to accommodate at least one child; and
c. allowing access for the child through an entry way into the area.

33. The teaching method of claim 32 wherein providing the entry way comprises providing a door into the fantasy-type structure.

34. The teaching method of claim 32, wherein providing the area comprises providing a room in the fantasy-type structure.

35. The teaching method of claim 32 wherein providing the fantasy-type structure comprises providing a simulated tree.

36. The teaching method of claim 35, wherein providing the entry way comprises providing a door in the trunk of the simulated tree.

37. The teaching method of claim 34, wherein providing the area comprises providing a room inside of the simulated tree.

38. The teaching method of claim 32, wherein allowing access through the entry way to the area comprises providing a reward for excellence in learning.

39. The teaching method of claim 32, wherein allowing access through the entry way to the area comprises providing a reward for good behavior.

40. A teaching aid for use in motivating children to learn, comprising:
d. a fantasy-type structure;
e. an area in the fantasy-type structure to accommodate at least one child; and
f. an entry way to enable access for the child into the area.

41. The teaching aid of claim 40, wherein the entry way comprises a door into the fantasy-type structure.

42. The teaching aid of claim 40, wherein the area is a room in the fantasy-type structure.

43. The teaching aid of claim 40, wherein the fantasy-type structure is a simulated tree.

44. The teaching aid of claim 43, wherein the entry way is a door in the trunk of the simulated tree.

45. The teaching aid of claim 43, wherein the area is a room inside of the simulated tree.
